(19) United States
(12) Patent Application Publication
(10) Pub. No.: US 2014/0232537 A1
(43) Pub. Date: Aug. 21, 2014

(54) METHOD AND DEVICE FOR SIGNALING THE PRESENCE OF A POTENTIAL OBSTACLE, SUCH AS A PEDESTRIAN, TO A VEHICLE DRIVER, AND IN PARTICULAR A MACHINE DRIVER

(71) Applicants: Jean-Marc Delprat, VieilleToulouse (FR); Andy Aguiere, Toulouse (FR); Francois Ravache, Pechabou (FR)

(72) Inventors: Jean-Marc Delprat, VieilleToulouse (FR); Andy Aguiere, Toulouse (FR); Francois Ravache, Pechabou (FR)

(73) Assignee: P.S.T., Toulouse (FR)

(21) Appl. No.: 14/117,060

(22) PCT Filed: May 12, 2011
(86) PCT No.: PCT/EP2011/057707

§ 371 Date: Mar. 20, 2014

(51) Int. Cl. B60Q 1/52; G01S 13/75

(52) U.S. Cl. CPC B60Q 1/525; G01S 13/751; G01S 2013/9339
USPC 340/435

(57) ABSTRACT

Disclosed is a method for signaling the presence of a potential obstacle, such as a pedestrian (P) to a vehicle driver (V), in particular a machine driver, wherein each obstacle (P) is provided with a transmitter (Em) capable of outputting a presence signal of the obstacle, and including two at least substantially orthogonal transmitting antennas (A1, A2) and power supply device (1-5) suitable for outputting in-phase quadrature signals to the antennas, and each vehicle (V) is provided with a receiver (Re) including two at least substantially orthogonal receiving antennas (Ax, Ay).

The invention relates to a method for signaling a potential obstacle, such as a pedestrian, to a vehicle driver, notably a machine driver. It extends to a signaling device to carry out this signaling method.

The risks of collision between vehicles, such as machines, and obstacles, such as pedestrians, in hostile environments such as construction sites, mines, etc., i.e. sites on which visibility is notably restricted, are high, and many, often fatal, accidents can currently be counted on sites of this type.

Many techniques have been developed for the purpose of reducing this number of accidents, and different techniques are cited, notably in the article written by M. Ruff and published in May 2000: “Test results of collision warning systems for surface mining dump trucks”.

One of these techniques, notably, considered as likely to provide an effective solution to the risks of accidents consists:
in equipping each pedestrian with transmission means, referred to as a transmitter, suitable for supplying a presence signal of said pedestrian,
in equipping each vehicle with means, referred to as a receiver, for receiving the presence signals transmitted by the transmitters of the pedestrians,
and in triggering audible and/or visual alarm means when a pedestrian is present in the vicinity of a vehicle.

This signaling technique is, moreover, described in a more detailed way, notably in the patent FR 2886440 and in the article written by M. Ruff and published in 1998: “Application of radio-frequency identification systems to collision avoidance in metal/nonmetal mines”, relating to a solution according to which the transmitters carried by pedestrians consist of RFID transmitters.

However, this technique has proven to have many disadvantages. In fact, and first and foremost, the transmitted waves often undergo multiple reflections on contact notably with metal structures and/or objects, and the waves reflected in this way interfere in a known manner with the signals picked up by the receivers and disrupt the overall operation of the signaling system.

Moreover, regardless of the influence of the reflections of the incident signals, the signals supplied by the transmitters were found to have been picked up correctly by the receivers only for a preferred orientation of the transmitters, corresponding, according to an obvious choice, to the standing position of the pedestrians. In other words, only persons in a standing position are correctly detected, whereas persons crouching or lying down, i.e., as a general rule, persons having a physical problem and therefore the most vulnerable persons, are not “seen” by means of the signaling system.

The present invention aims to overcome these disadvantages and its first object is to provide a method for signaling obstacles such as pedestrians, consisting of equipping said pedestrians with a transmitter of which the detection is guaranteed regardless of the spatial orientation of said transmitter.

A different object of the invention is to provide a signaling method which is insensitive to the presence of metal structures and/or objects.

For this purpose, the invention aims to provide a method for signaling a potential obstacle, such as a pedestrian, to a vehicle driver, notably a machine driver, consisting of equipping each obstacle with transmission means, referred to as a transmitter, suitable for supplying a presence signal of said obstacle, and each vehicle with means, referred to as a receiver, for receiving the presence signals transmitted by the transmitters of the obstacles. Moreover, alarm means are triggered when an obstacle is present in the vicinity of a vehicle, which alarm means may be of any type suitable for attracting the attention of the driver of the vehicle and/or a pedestrian near the vehicle, such as audible and/or visual alarm means.

According to the invention, this signaling method is characterized in that the following are used:
transmitters comprising two at least substantially orthogonal transmit antennas, and supply means adapted to supply quadrature-phase signals to said antennas,
and receivers comprising two at least substantially orthogonal receive antennas.

According to this method, each transmitter is therefore equipped with two orthogonal transmit antennas supplied with quadrature-phase signals in such a way that these two antennas do not interfere with one another and generate two magnetic fields in two different directions, while each receiver comprises two orthogonal receive antennas.

Arrangements of this type guarantee the reception of the signals transmitted by the transmitters regardless of the orientation of said transmitters and regardless of the orientation of the receivers. In fact, the substantially orthogonal receive antennas of one receiver extend substantially in one plane, and only a signal transmitted by a transmit antenna substantially orthogonal to this plane is not picked up by this receiver. It is understood that no orientation of the transmitter can result in the transmit antennas both being orthogonal to the plane in which the two receive antennas extend.

According to particular embodiments, the signaling method comprises one or more of the following characteristics, taken in isolation or according to all technically possible combinations.

According to one advantageous embodiment, the two at least substantially orthogonal receive antennas of each receiver are arranged in such a way that said two receive antennas extend in an at least substantially horizontal plane.

Arrangements of this type are particularly advantageous since the inventors noted during tests in a hostile environment (construction site, mine, etc.) that the signals picked up by a receive antenna oriented according to a vertical axis are affected by substantial interference from the materials of the vehicle and the ground. This interference is consequently substantially reduced by arranging the receive antennas in such a way that they extend in a substantially horizontal plane.

As previously indicated, this arrangement of the receive antennas guarantees the reception of the signals transmitted by the transmitters regardless of their orientation. In fact, in the most unfavorable case corresponding to a lying position of the pedestrian, where one of the antennas of a transmitter is oriented according to a vertical axis, the second antenna is necessarily located in a horizontal plane, in such a way that the signal transmitted by this second antenna is necessarily picked up by at least one of the receive antennas.

Moreover, in all other conceivable positions of the carrier of a transmitter (seated, crouching, standing position, etc.), the signals transmitted by the two transmit antennas necessarily comprise a horizontal component which guarantees their reception by the receivers with which the vehicles are equipped.

According to one advantageous embodiment, each transmitter is adapted to transmit a presence signal at frequencies below 1000 kHz. Such arrangements guarantee that a so-called zone of interest within a radius of at least 30 meters around this transmitter is located in the near-field radiation zone of this transmitter.

The zones of interest are zones around the obstacles in which the presence of a vehicle equipped with a receiver must trigger audible and/or visual alarm means. Thus, when a vehicle equipped with a receiver is located in the zone of interest of an obstacle, it will be in near-field reception conditions.

In a manner known per se, the near-field reception conditions are checked for a distance to the transmitter of less than λ/2π, an expression in which λ denotes the wavelength of the presence signal. Since the zone of interest is located in the near-field radiation zone, the electromagnetic wave propagation pattern is not yet established, in such a way that, in the near field, there are no reflection phenomena that would interfere with the reception of the presence signals.

According to one advantageous embodiment, the presence signal transmitted by each transmitter is an uninterrupted signal. In other words, the presence signal, when it is transmitted, is a continuous signal including no silences. Thus, when a presence signal is transmitted, said signal can be received at any time by a vehicle equipped with a receiver.

For example, the supply means of each transmitter are adapted to supply signals to the transmit antennas such that, when a presence signal is transmitted, at least one of said antennas is always supplied with a non-zero signal.

Such arrangements strengthen the reliability of the detection of the potential obstacles notably to the extent that the transmission of an uninterrupted signal enables an obstacle to be detected more quickly. It is in fact understood that, in the opposite case, the transmission of a signal comprising silences, for example recurrent pulses, does not enable an obstacle to be detected during the silences since no signal can be detected by the receivers during these silences.

Moreover, the transmission of an uninterrupted signal enables the received signal-to-noise ratio to be improved and therefore the presence of a potential obstacle to be detected sooner. This is all the more important when zones of interest are located in the near-field radiation zone. In fact, the intensity of the magnetic field is then measured, which decreases very rapidly with distance (decreases substantially as the inverse of the cube of the distance). By increasing the received signal-to-noise ratio, the minimum distance at which an obstacle can be detected can be increased.

According to one advantageous embodiment, each of said transmitters is adapted to transmit a presence signal consisting of a non-frequency-modulated and a non-amplitude-modulated carrier. A presence signal of this type is, for example, obtained by supplying the transmit antennas of the transmitter with substantially sinusoidal quadrature-phase signals (phase-shifted by π/2).

Arrangements of this type make it possible to identify each transmitter of which the signal is received by a receiver, to record the number of transmitters of which the signals are picked up by a receiver, and to avoid interference in the case where the signals transmitted by a plurality of transmitters are received simultaneously by one receiver.

Moreover, the use of uninterrupted presence signals consisting of non-frequency-modulated carriers offers the advantage that there are no interfering signals presenting such characteristics in construction sites, mines, etc., so that the probability of confusing a presence signal with an interfering signal is very low. For the purpose of identifying the transmitters, each transmitter advantageously comprises a specific transmit frequency dedicated to said transmitter, and each receiver advantageously consists of a multi-channel receiver comprising means for independent detection of the signals transmitted by the different transmitters.

This arrangement enables the detection in an independent manner of as many transmitters as channels of the multi-channel receivers. Furthermore, the use of presence signals consisting of non-frequency-modulated carriers results, for each presence signal, in a very low spectral occupancy, in such a way that the specific transmit frequencies of each transmitter can be very close, for example with a 100 Hz spacing. It is understood that many transmitters can then coexist in a reduced frequency band.

Moreover, it is thus ensured that the presence signals of different transmitters do not interfere with one another in the receiver. Interference of this type would degrade obstacle detection reliability, since it would result in a significant degradation of the accuracy of the estimation of the distance between the vehicle and an obstacle.

The fact that the presence signals are uninterrupted signals also contributes to the spectral occupancy of each presence signal being very low and to the presence signals of different transmitters not causing interference. In fact, in the opposite case of an intermittent signal containing silences, the spectral occupancy is increased during the transitions to/from silences, which would be likely to create intermittent interference for the presence signals transmitted by other transmitters.

It is therefore understood that the combination of uninterrupted presence signals consisting of non-frequency-modulated and non-amplitude-modulated carriers on the one hand, and specific transmit frequencies dedicated to each transmitter on the other hand, constitutes a particularly reliable and robust embodiment.

Moreover, according to one advantageous embodiment of the invention, transmit beacons comprising transmit means adapted to supply a signal to inhibit the operation of the transmitters are positioned in so-called secure zones such as construction site shelters, vehicle cabs, etc. Moreover, each transmitter then advantageously comprises means for receiving the inhibition signals, and is adapted to interrupt the transmission of the presence signals when an inhibition signal is received.

The presence of beacons in vehicle cabs interrupts the transmission of the presence signals by the transmitter carried by a pedestrian located in said cab, thereby avoiding an unwarranted, untimely triggering of the alarm means. Moreover, these beacons located in the vehicle cabs also prevent the receivers of the vehicles from detecting the transmitters positioned in the cabs of other vehicles.

Moreover, when they are positioned in secure zones such as a construction site shelter, etc., such beacons also prevent unwarranted, untimely triggering of the alarm means.

It must, furthermore, be noted that, regardless of the position of the beacons, said beacons advantageously result in the control of an operation of the transmitters in a “standby” mode corresponding to a low power consumption mode.

In a general manner, it is noted that the use of beacons transmitting an inhibition signal and transmitters adapted to interrupt the transmission of the presence signals when an inhibition signal is received aims to interrupt the transmission of presence signals when the transmitters are located in secure zones. It is therefore understood that the use of such beacons and such transmitters is not limited to signaling devices with transmitters comprising two at least substantially orthogonal transmit antennas and receivers comprising two at least substantially orthogonal receive antennas. On the contrary, the use of such beacons and such transmitters extends to other configurations of transmit antennas and/or to other configurations of receive antennas.

By way of an advantageous embodiment of the invention, the means for transmitting the inhibition signal with which each transmitting beacon is equipped consists of active RFID transmitters.

Furthermore, for the purpose of reliability of the method according to the invention and for security purposes, each transmitter is advantageously equipped with an auto-test circuit for detecting operational anomalies of said transmitter, and audible and/or visual and/or electromechanical (buzzer, etc.) alarm means adapted to be activated when an operational anomaly is detected.

The aim of this auto-test procedure is notably to detect anomalies such as: low battery charge, insufficient generated magnetic field, frequency-generating oscillator anomaly (HF driver), etc.

Similarly for reliability and security purposes, each receiver is advantageously equipped:
with a test circuit comprising a test loop arranged near to the receive antennas and means for supplying said test loop with a signal at a predetermined test frequency,
and audible and/or visual alarm means adapted to be activated when an operational anomaly of the reception chain is detected by the test circuit.

The predetermined test frequency is preferably a central receive frequency. The central receive frequency is defined as being the frequency which, following frequency translation of the received presence signals in order to adjust them to the baseband, is substantially centered on 0 Hz. The choice of such a test frequency is advantageous since this frequency is generally severely affected by interference, so that it is not usable for exchanging data. However, this interference does not prevent the detection and analysis, by the reception chain of the receiver, of a signal transmitted at this test frequency for the purpose of detecting an operational anomaly of the receiver.

According to a different advantageous embodiment of the invention, and for the purpose of signaling the presence of an obstacle, each vehicle is equipped with means for processing the presence signals transmitted by the transmitters, adapted to compute values representing the distance separating each obstacle from said vehicle, and audible and/or visual alarm means adapted to be activated by the processing means when the distance between an obstacle and the vehicle becomes less than a determined threshold.

Moreover, the processing means are then advantageously programmed to compute, for each obstacle, the relative closing speed between said obstacle and the vehicle equipped with said processing means, on the basis of the variations in the level (power, intensity of the magnetic field, etc.) of the presence signal received from the transmitter of said obstacle, and to adjust the threshold value of the distance of activation of the alarm means according to the value of said closing speed.

The aim of this function which consists in estimating the relative closing speed is to modify the detection threshold in order to alert sooner in the event of a fast closing speed and later in the event of a slow closing speed. Moreover, in the event of a distancing (negative closing speed), this function enables the alarm to be stopped.

The invention extends to a device for signaling a potential obstacle, such as a pedestrian, to a vehicle driver, notably a machine driver, including:
adapted for equipping each obstacle: transmission means, referred to as a transmitter, suitable for supplying a presence signal of said obstacle,
adapted for equipping each vehicle: means, referred to as a receiver, for receiving the presence signals transmitted by the transmitters of the obstacles,
and alarm means adapted to be triggered in the event of the presence of an obstacle in the vicinity of a vehicle, which alarm means may be of any type suitable for attracting the attention of the driver of the vehicle and/or a pedestrian near the vehicle, such as audible and/or visual alarm means.

According to the invention, this signaling device is characterized in that:
each transmitter comprises two at least substantially orthogonal transmit antennas, and activation means adapted to supply quadrature-phase signals to said antennas,
and each receiver comprises two at least substantially orthogonal receive antennas.

According to particular embodiments, the signaling device comprises one or more of the following characteristics, taken in isolation or according to all technically possible combinations.

According to one advantageous embodiment, the two at least substantially orthogonal receive antennas are intended to be arranged in such a way that said two receive antennas extend in an at least substantially horizontal plane.

According to one advantageous embodiment, each transmitter is adapted to transmit a presence signal at frequencies below 1000 kHz.

According to one advantageous embodiment, the presence signal transmitted by each transmitter is an uninterrupted signal.

Furthermore, according to one advantageous embodiment, the signaling device advantageously comprises transmitting beacons intended to be positioned in so-called secure zones such as construction site shelters, vehicle cabs, etc., and comprising transmission means adapted to supply a so-called inhibition signal, each of the transmitters comprising means for receiving said inhibition signal and being adapted to interrupt the transmission of the presence signals when an inhibition signal is received.

As previously indicated, the use of such beacons and such transmitters is not limited to signaling devices comprising transmitters comprising two at least substantially orthogonal transmit antennas and receivers comprising two at least substantially orthogonal receive antennas.

The invention furthermore extends to a signaling device comprising, taken alone or in combination, any one of the characteristics set out in the claims of the present application and/or described in the description of the present application.

Other characteristics, objects and advantages of the invention will become evident from the detailed description which follows with reference to the attached drawings which represent an embodiment thereof by way of a non-limiting example. In these drawings:

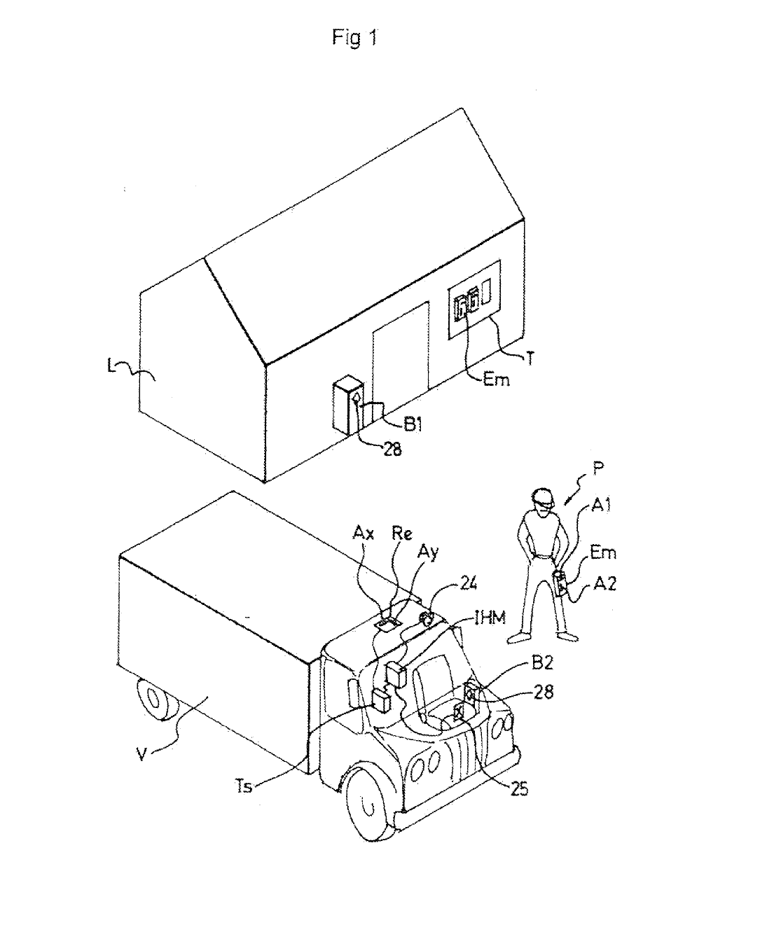

FIG. 1 is a diagram showing a construction site on which the premises, personnel and vehicles are equipped with the signaling device according to the invention,

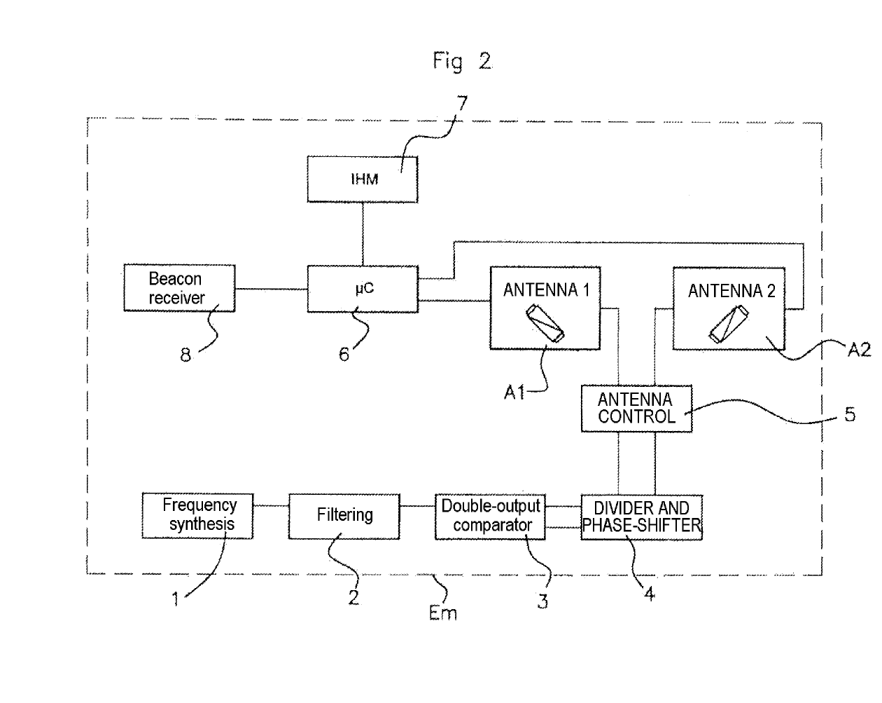

FIG. 2 is a functional block diagram of a transmitter of the signaling device according to the invention,

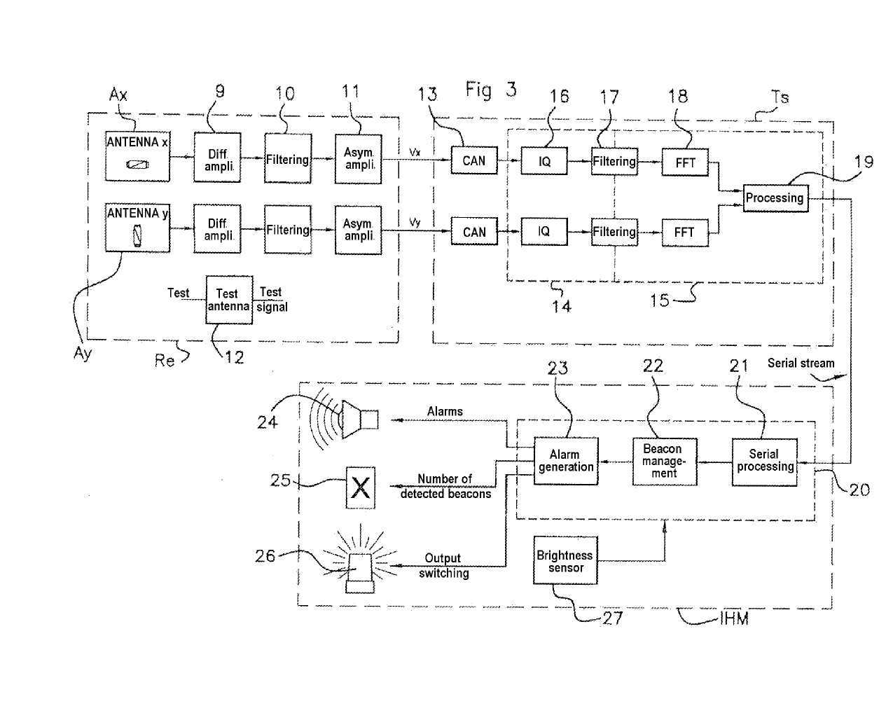

and FIG. 3 is a functional block diagram of a receiver and of means for processing the presence signals of the signaling device according to the invention.

The aim of the signaling device according to the invention shown schematically in FIG. 1 is to ensure the protection of the pedestrians P moving in a low-visibility hostile zone, such as a construction site, a mine, etc., in which vehicles V, such as construction site machines, are moving.

For this purpose, the principle of the invention is to equip:
each pedestrian P with a transmitter Em designed to transmit a presence signal consisting of a non-frequency-modulated carrier dedicated to each transmitter,
each vehicle V with a receiver Re to receive the presence signals transmitted by the transmitters Em, means for processing said presence signals, and alarm means adapted to be activated by the processing means when the distance between a pedestrian and the vehicle becomes less than a determined threshold, and for alerting the pedestrian P and the driver of the vehicle V at the same time.

First and foremost, each transmitter Em is provided in the form of a portable housing integrating, apart from the components described below, power supply means, such as a battery (not shown), rechargeable, for example, on a power supply panel T situated in an appropriate building L, such as a construction site building, locker room, etc.

As shown in FIG. 2, each of these transmitters Em comprises two antennas A1, A2 conventionally comprising a coil arranged around a ferrite bar, said antennas presenting, according to the invention, the particular features of being:
physically arranged in quadrature, i.e. arranged in such a way that the longitudinal axes of the two ferrite bars extend according to perpendicular axes,
electrically supplied by quadrature-phase signals.

For the purpose of this electrical supply, each transmitter Em comprises, as shown in FIG. 2, a frequency-generating oscillator 1, a filtering module 2, a double-output comparator 3, the two outputs of which are connected to a divider and phase-shifter module 4, the outputs of which are connected to a module 5 for controlling the two antennas A1, A2.

These components are, moreover, designed so that each antenna A1, A2 transmits an uninterrupted presence signal consisting of a non-frequency-modulated carrier substantially between 400 kHz and 500 kHz. A presence signal of this type is, for example, obtained by supplying the transmit antennas of the transmitter Em with substantially sinusoidal signals at the same quadrature-phase frequency (phase-shifted by π/2).

Moreover, these components are also designed so that each transmitter (Em) comprises a specific transmit frequency dedicated to said transmitter.

As examples of frequency values, the frequencies of the transmitters can be selected in a frequency band centered on a median value of 450 kHz, with a step of 100 Hz between two adjacent frequencies. Such a choice of frequencies ensures that a so-called zone of interest within a radius of at least 30 meters around this transmitter is located in the near-field radiation zone, insofar as the value of the λ/2π ratio is, at 450 kHz, greater than 100 meters.

Each transmitter Em also comprises a microprocessor 6 to which two control signals are supplied which represent the magnetic fields transmitted by each of the antennas A1, A2.

This microprocessor 6 is notably programmed to have an auto-test function based notably on the analysis of the signals originating from the two antennas A1, A2, for detecting operational anomalies of the transmitter Em, such as: low battery charge, insufficient generated magnetic field, anomaly of the frequency-generating oscillator 1 (HF driver).

Moreover, this microprocessor 6 is connected to an interface 7 comprising notably audible and/or visual and/or electromechanical alarm means of a type known per se, adapted to be activated when an operational anomaly is detected.

Finally, each transmitter Em comprises a receiver 8 adapted to receive inhibition signals originating from beacons B1, B2 positioned in secure zones, on reception of which the microprocessor 6 is programmed to interrupt the transmission of the presence signals.

As shown in FIG. 1, the beacons B1, B2 are intended to be positioned:
on the one hand, in buildings L such as construction site shelters, etc. (beacons B1), i.e. in places where personnel are sheltered from vehicles V,
on the other hand, in the cabs of vehicles V (beacon B2).

For the purpose of transmitting inhibition signals, each beacon B1, B2 comprises an active RFID transmitter 28 or “active RFID identifier”, the coverage zone of which is adjusted in such a way as to correspond to the area of the secure zone.

Each multi-channel receiver Re is, for its part, intended to be arranged on the roof of the cab of the vehicle V. As shown in FIG. 3, each of these multi-channel receivers Re comprises two antennas Ax, Ay conventionally comprising a coil arranged around a ferrite bar, said antennas being:
physically arranged in quadrature, i.e. arranged in such a way that the longitudinal axes of the two ferrite bars extend according to perpendicular axes,
intended to extend in a substantially horizontal plane.

Each multi-channel receiver Re furthermore comprises, associated with each antenna Ax, Ay, a reception chain, at the output of which a signal Vx, Vy respectively is supplied, each of the reception chains comprising a differential amplifier 9, a filtering module 10 and an asymmetrical amplifier 11.

Finally, each multi-channel receiver Re comprises a test circuit comprising a test loop 12 arranged near to the receive antennas Ax, Ay, adapted to be supplied with a signal at a predetermined test frequency generated by the processing unit described below, and intended to signal any operational anomaly of the reception chain.

The means for processing the signals Vx, Vy originating from a multi-channel receiver Re comprise, first and foremost, a processing unit Ts consisting of a housing intended to be accommodated in the cab of the vehicle V.

This processing unit Ts comprises, first and foremost, for each line Vx, Vy, an analog converter 13.

This processing unit Ts also comprises a programmable logic circuit 14 and a microprocessor 15 suitable for converting the raw data originating from the converters 13 into a differential spectrum in a predetermined frequency band, and for processing this differential spectrum in order to carry out, for each receive channel, according to the received presence signal and the variations in the level of this presence signal, an estimation of:
the distance separating the transmitter Em and the vehicle V,
the relative closing speed between the transmitter Em and the vehicle V, for the purpose of adjusting the threshold value of the alarm-triggering distance.

For this purpose, the programmable logic circuit 14 and the microprocessor 15 incorporate, for each line Vx, Vy, an “IQ” module 16 for translating the frequencies into a frequency band centered around the value 0 Hz, a signal filtering and shaping module 17, and an “FFT” module for carrying out Fourier transforms.

Finally, this programmable logic circuit 14 and this microprocessor 15 comprise a single processing module 19 for processing the signals originating from the two “FFT” modules 18, at the output of which a serial data stream is supplied.

The means for processing the signals Vx, Vy also comprise an alarm unit IHM intended to be accommodated in the cab of the vehicle V, to which the serial data stream originating from the processing unit Ts is supplied.

This alarm unit IHM comprises, first and foremost, a microprocessor 20 comprising a module 21 for processing the serial stream, a module 22 for managing the different transmitters Em and a module 23 for generating alarms intended for:
audible and/or visual alarm means 24 intended to be arranged in the cab of the vehicle V for the purpose of alerting the driver,
a display 25, to display, for example, the number of detected transmitters Em,
and audible and/or visual alarm means 26 intended to be arranged on the roof of the cab of the vehicle V for the purpose of alerting pedestrians.

Moreover, this alarm unit IHM comprises a brightness sensor 27 for adjusting the brightness of the display 25.

A signaling device of this type, first and foremost, guarantees the reception of the signals transmitted by the transmitters regardless of their orientation, and therefore, in the case of pedestrians, regardless of the position of the latter.

Moreover, this signaling device makes it possible to identify each transmitter of which the signal is received by a receiver, to record the number of transmitters of which the signals are picked up by a receiver, and to avoid interference when the signals transmitted by a plurality of transmitters are received simultaneously by one receiver.

1-17. (canceled)

18. A method for signaling a potential obstacle, such as a pedestrian (P), to a vehicle driver (V), notably a machine driver, wherein:
each obstacle (P) is equipped with transmission means (Em), referred to as a transmitter, adapted to supply a presence signal of said obstacle,
each vehicle (V) is equipped with means (Re), referred to as a receiver, for receiving the presence signals transmitted by the transmitters (Em) of the obstacles (P),
and alarm means (24, 26) are triggered when an obstacle (P) is present in the vicinity of a vehicle (V),
wherein the following are used:
transmitters (Em) comprising two at least substantially orthogonal transmit antennas (A1, A2), and supply means (1-5) adapted to supply quadrature-phase signals to said antennas,
and receivers (Re) comprising two at least substantially orthogonal receive antennas (Ax, Ay).

19. The signaling method as claimed in claim 18, wherein each transmitter (Em) is adapted to transmit a presence signal at frequencies below 1000 kHz, in such a way that a so-called zone of interest within a radius of at least 30 meters around this transmitter is located in the near-field radiation zone of this transmitter.

20. The signaling method as claimed in 18, wherein the presence signal transmitted by each transmitter (Em) is an uninterrupted signal.

21. The signaling method as claimed in claim 20, wherein each transmitter (Em) is adapted to transmit a presence signal consisting of a non-frequency-modulated carrier.

22. The signaling method as claimed in claim 21, wherein each transmitter (Em) comprises a specific transmit frequency dedicated to said transmitter, each receiver (Re) consisting of a multi-channel receiver comprising means for independent detection of the signals transmitted by the different transmitters.

23. The signaling method as claimed in claim 18, comprising positioning, in so-called secure zones, transmitting beacons (B1, B2) comprising transmission means (28) adapted to supply a signal to inhibit the operation of the transmitters (Em), each of said transmitters comprising means (8) for receiving said inhibition signal and being adapted to interrupt the transmission of the presence signals when an inhibition signal is received.

24. The signaling method as claimed in claim 23, wherein the means for transmitting the inhibition signal with which each transmitting beacon (B1, B2) is equipped consist of active RFID transmitters (28).

25. The signaling method as claimed in claim 18, wherein each transmitter (Em) is equipped with an auto-test circuit (6) for detecting operational anomalies of said transmitter, and audible and/or visual and/or electromechanical alarm means (7) adapted to be activated when an operational anomaly is detected.

26. The signaling method as claimed in claim 18, wherein each receiver (Re) is equipped:
with a test circuit comprising a test loop (12) arranged near to the receive antennas (Ax, Ay) and means for supplying said test loop with a signal at a predetermined test frequency,
and audible and/or visual alarm means (25) adapted to be activated when an operational anomaly of the reception chain is detected by the test circuit.

27. The signaling method as claimed in claim 18, wherein, for the purpose of signaling the presence of an obstacle (P), each vehicle (V) is equipped with means (Ts) for processing the presence signals transmitted by the transmitters (Em), adapted to compute values representing the distance separating each obstacle (P) from said vehicle, and alarm means (24, 26) adapted to be activated by the processing means when the distance between an obstacle and the vehicle becomes less than a determined threshold.

28. The signaling method as claimed in claim 27, wherein the processing means (Ts) are programmed to compute, for each obstacle (P), the relative closing speed between said obstacle and the vehicle (V) equipped with said processing means, on the basis of the variations in the level of the presence signal received by the receiver (Re) of said obstacle, and to adjust the threshold value of the distance of activation of the alarm means (24, 26) according to the value of said closing speed.

29. The signaling method as claimed in claim 18, wherein the two at least substantially orthogonal receive antennas of each receiver are arranged in such a way that said two receive antennas extend in an at least substantially horizontal plane.

30. A device for signaling a potential obstacle, such as a pedestrian (P), to a vehicle driver (V), notably a machine driver, wherein it comprises:
adapted for equipping each obstacle (P): transmission means (Em), referred to as a transmitter, suitable for supplying a presence signal of said obstacle,
adapted for equipping each vehicle (V): means (Re), referred to as a receiver, for receiving the presence signals transmitted by the transmitters (Em) of the obstacles (P),
and alarm means (24, 26) adapted to be triggered when an obstacle (P) is present in the vicinity of a vehicle (V),
wherein:
each transmitter (Em) comprises two at least substantially orthogonal transmit antennas (A1, A2), and supply means (1-5) adapted to supply quadrature-phase signals to said antennas,
and each receiver (Re) comprises two at least substantially orthogonal receive antennas (Ax, Ay).

31. The signaling device as claimed in claim 30, wherein each transmitter (Em) is adapted to transmit a presence signal at frequencies below 1000 kHz, in such a way that a so-called zone of interest within a radius of at least 30 meters around this transmitter is located in the near-field radiation zone of this transmitter.

32. The signaling device as claimed in claim 30, wherein the presence signal transmitted by each transmitter (Em) is an uninterrupted signal.

33. The signaling device as claimed in claim 30, comprising transmitting beacons (B1, B2), intended to be positioned in so-called secure zones, and comprising transmission means (28) adapted to supply a signal to inhibit the operation of the transmitters (Em), each of said transmitters comprising means (8) for receiving said inhibition signal and being adapted to interrupt the transmission of the presence signals when an inhibition signal is received.

34. The signaling device as claimed in claim 30, wherein the two at least substantially orthogonal receive antennas of each receiver are intended to be arranged in such a way that said two receive antennas extend in an at least substantially horizontal plane.
